(19) United States
(12) Patent Application Publication
(10) Pub. No.: US 2023/0071719 A1
(43) Pub. Date: Mar. 9, 2023

(54) SYSTEMS AND METHODS FOR SELECT RADIO UNIT TRANSMISSION POWER IN RADIO ACCESS NETWORKS

(71) Applicant: CommScope Technologies LLC, Hickory, NC (US)

(72) Inventors: Suresh N. Sriram, Bangalore (IN); Milind Kulkarni, Hawthorn Woods, IL (US); Ehsan Daeipour, Southborough, MA (US)

(73) Assignee: CommScope Technologies LLC, Hickory, NC (US)

(21) Appl. No.: 17/903,707

(22) Filed: Sep. 6, 2022

Related U.S. Application Data
(60) Provisional application No. 63/241,139, filed on Sep. 7, 2021.

(51) Int. Cl. H04W 52/14; H04W 52/34; H04W 52/24

(52) U.S. Cl. CPC H04W 52/143; H04W 52/34; H04W 52/242

(57) ABSTRACT

Systems and methods for select RU transmission power in RANs are provided. In one embodiment, a controller for a RAN is provided. The RAN includes a BBU entity coupled to a plurality of RUs providing wireless communications service to UEs in a coverage area, the controller comprises a processor executing: a power assessment function that determines a transmit power level for RUs based on RU configuration data; an information block dissemination function that communicates an information block to the RUs based on the transmit power level determined by the power assessment function; the information block dissemination function communicates a first information block to a RU that indicates a first power level, and a second information block to a second RU that indicates a second power level different than the first; within the coverage area, the downlink signals of the first RU are isolated from downlink signals of the second RU.

### CROSS-REFERENCE TO RELATED APPLICATIONS

This application claims priority to U.S. Provisional Patent Application No. 63/241,139 filed on Sep. 7, 2021, titled “SYSTEMS AND METHODS FOR SELECT RADIO UNIT TRANSMISSION POWER IN RADIO ACCESS NETWORKS,” the contents of which are incorporated herein by reference in their entirety.

### BACKGROUND

In conventional cellular radio access networks (RANs), user equipment (UE) throughput is degraded when the pathloss to the base station serving that UE has a level similar to the pathloss to a neighboring base station. The degraded throughput is a consequence of the high intercell interference in such “border” regions, as well as the lower receive signal power relative to locations closer to the serving base station. If the UE moves toward the neighboring base station, eventually the UE's connection will be handed over to the neighboring base station, where it will continue to experience degraded throughput in the border region.

One type of RAN is a centralized or cloud radio access network (C-RAN). Typically, for each cell (that is, for each physical cell identifier (PCI)) implemented by a C-RAN, a centralized set of baseband unit (BBU) entities interacts with multiple remote units (“RUs,” also referred to here as “radio points” or “RPs”) in order to provide wireless service to various items of user equipment (UEs). The BBU entities may comprise a single entity (sometimes referred to as a “baseband controller” or simply a “baseband band unit” or “BBU”) that performs Layer-3, Layer-2, and some Layer-1 processing for the cell. The BBU entities may also comprise multiple entities, for example, one or more central unit (CU) entities that implement the control-plane and user-plane Layer-3 functions for the cell, and one or more distribution units (DU) that implement the Layer-2 functions for cell and some of the control-plane and user-plane Layer-1 functions for cell. In general, the remote units implement the control-plane and user-plane Layer-1 functions not implemented by the BBU entities as well as the radio frequency (RF) functions. The multiple remote units are typically located remotely from each other (that is, the multiple remote units are not co-located). The BBU entities are communicatively coupled to the remote units over a fronthaul network. They may be collocated in instances where each remote unit processes different carriers or time slices.

A RAN implementing a Single PCI scheme simulcasts signals in the downlink direction from multiple RUs to the UE (and in the uplink combines UE signals received by multiple RUs). By doing so, such RAN provide a high user experience quality throughout the deployment including for UEs that are located in region midway between RUs. A reuse feature, which may be referred to as joint transmission and joint reception, allows the RAN to identify UEs that are spatially isolated and associate those UEs with a subset of the RAN's RUs. The reuse feature further allows the RAN to schedule those UEs on the same physical resource blocks (PRBs) while maintaining service quality. This feature is referred to as “reuse” since the same PRBs are used (“reused”) to simultaneously communicate with different UEs using the different subsets of different RUs. The same frequency, bandwidth, and/or time can be scheduled for communicating with the UEs in this muti-radio environment. The BBU is configured to employ such reuse for two or more UEs only in those situations where the UEs are sufficiently isolated from one another (either by physical separation or other sufficient radio frequency (RF) isolation) to avoid significant co-channel interference resulting from the simultaneous communications. Transmitting from multiple RUs to a single UE, and combining uplink data received from a single UE using multiple RUs, can also effectively boost the signal power and quality (for example, signal-to-interference-plus-noise ratio (SINR)).

In such C-RANs, each of the RUs transmit to the UE within the C-RAN's coverage area at the same signal power so that the total RU coverage is the same. The signal power level being used is periodically broadcast to the UE within the coverage area in resource blocks referred to as the System Information Block (SIB). For example, in LTE systems the reference signal power is broadcast via the SIB2, while in 5G systems SSB signal power is broadcast via the SIB1. The UEs read system information from the SIB to acquire parameters used for cell selection, cell reselection, handover, downlink path reporting, and other purposes. The parameters acquired include an indication of the signal power being used by the RU to transmit into the coverage area. Upon receiving the signal power information, the UE estimates the signal power from the received signal from the network and computes an estimated path loss of the transmission medium between the RU and the UE. As a function of the estimated path loss and instructions from the RAN, the UE adjusts its own transmit signal power for uplink communications.

Within facilities where uniform coverage is desired throughout, such as inside an office building or within a stadium or arena, having the RU each transmit at the same signal power can be advantageous with respect to implementing PRB reuse schemes because the signal power levels that avoid significant co-channel interference can be readily computed. That said, providing communications connectivity to a large open area adjacent to the facility, such as a parking lot or garage, is often more efficiently provided by a single RU (or a small group of RUs) that transmit at higher signal powers than those RUs deployed inside the facility. However, to provide that outside coverage using the higher power RUs (for example, higher than the transmit power used by the inside RUs), a separate BBU needs to be deployed, along with the corresponding additional support infrastructure (power resources, switching equipment, etc.) to establish a separate stand-alone cell and PCI.

### SUMMARY

Systems and methods for select radio unit transmission power in radio access networks are provided. In one embodiment, a controller for a radio access network is provided wherein the radio access network includes a baseband controller coupled to a plurality of radio units providing wireless communications service to user equipment (UE) in a coverage area, the controller comprising: a processor configured to execute: a radio unit power assessment function, wherein the remote unit power assessment function determines a transmit power level for each of the plurality of radio units based on radio unit configuration data; an information block dissemination function configured to communicate an information block to each of the plurality of radio units based on the transmit power level for each of the plurality of radio units determined by the radio unit power assessment function; wherein the information block dissemination function communicates a first information block to a first radio unit that indicates to transmit downlink signals into a coverage area at a first power level; wherein the information block dissemination function communicates a second information block to a second radio unit that indicates to transmit downlink signals into the coverage area at a second power level either greater or less than the first power level; and wherein within the coverage area, the downlink signals of the first radio unit are isolated from downlink signals of the second radio unit.

### DRAWINGS

Embodiments of the present disclosure can be more easily understood and further advantages and uses thereof more readily apparent, when considered in view of the description of the preferred embodiments and the following figures in which:

FIG. 1 is a diagram of an example radio access network embodiment.

FIGS. 1A and 1B are diagrams of example baseband unit entities.

FIGS. 2 and 2A are diagrams of an example radio access network implementation where at least one radio unit operates at a higher transmit signal power than used other remote units.

FIG. 3 is a flow chart illustrating a method embodiment.

In accordance with common practice, the various described features are not drawn to scale but are drawn to emphasize features relevant to the present disclosure. Reference characters denote like elements throughout figures and text.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized and that logical, mechanical and electrical changes may be made without departing from the scope of the present disclosure. The following detailed description is, therefore, not to be taken in a limiting sense.

Embodiments of the present disclosure provide for radio access networks, such as C-RAN or other RAN, having RUs of differing transmit signal powers. More specifically, the RAN includes a BBU coupled to a plurality of RUs, where at least one RU is configured to transmit RF signals into the coverage area at a transmit signal power different than used by the other RUs of the RAN. Moreover, the BBU generates and sends to the at least one RU a different SIB than it sends to the other RUs so that UEs throughout the coverage area receive an accurate indication of the transmit power level of the RU(s) they are actively connected to. Because the transmit signal power at select RUs can be different, their signal power can be tailored to provide the coverage and capacity as per the deployment need. RF signal isolation methods, whether active or passive, are utilized to facilitate PRB reuse in such embodiments where not all RUs are transmitting at the same signal power. The total transmit energy is computed as the Effective Isotropic Radiated Power (EIRP), which includes RU gain in addition to internal or external antenna gain. The embodiments disclosed herein address providing different total transmit energy from different RUs based on the combination of both RU an antenna gain. It should be understood that the RU power that an RU may transmit is not only a function of the maximum transmit power supported by hardware, but also based on emission level considerations and regulatory certifications.

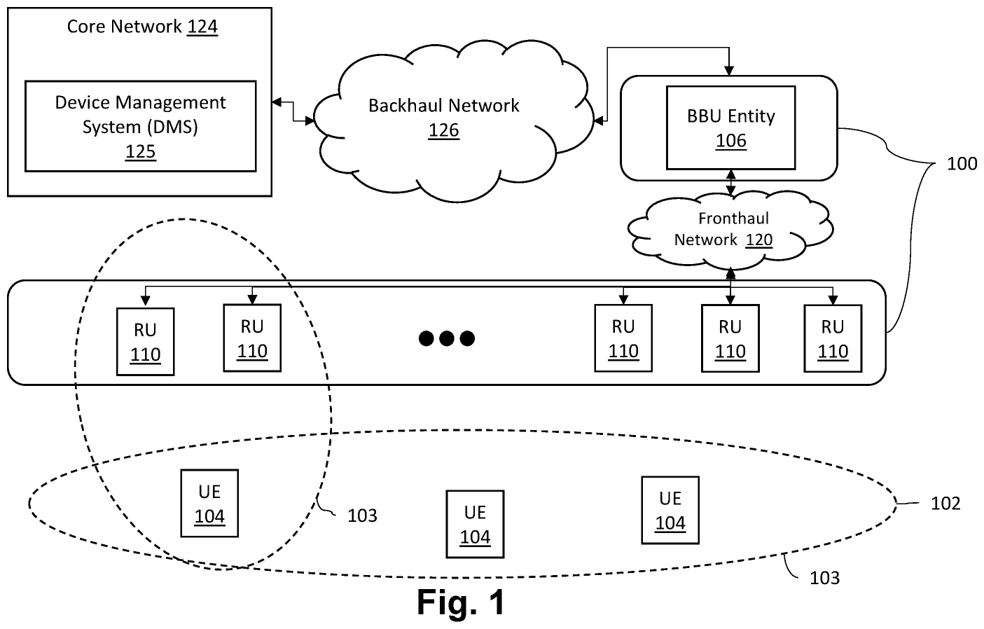

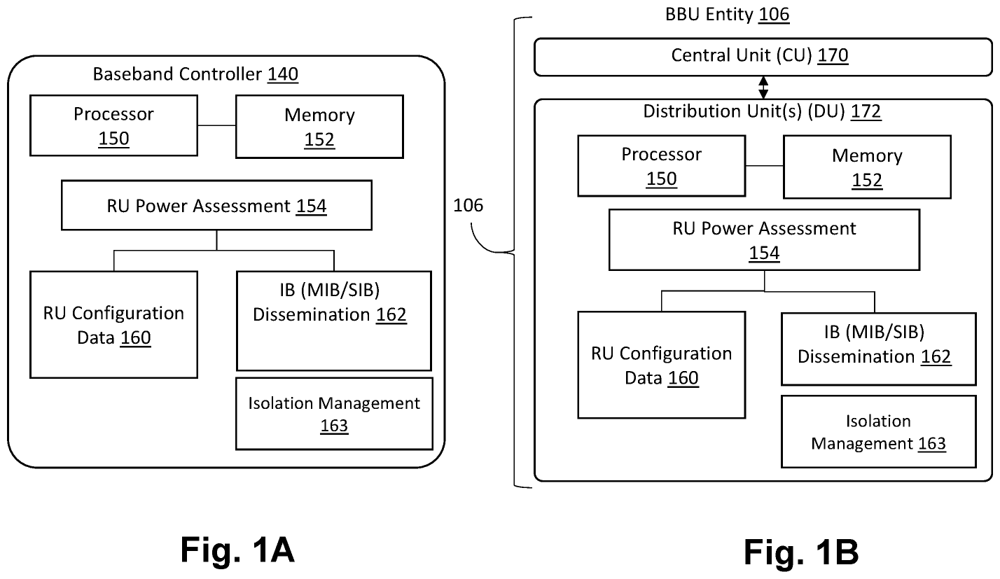

FIG. 1 is a block diagram illustrating one exemplary embodiment of a radio access network (RAN) system 100 in which the techniques described below can be used. The RAN system 100 shown in FIG. 1 implements a base station entity for serving each cell 102. The RAN system 100 can also be referred to here as a “base station” or “base station system” (and, which in the context of a fourth generation (4G) Long Term Evolution (LTE) system, may also be referred to as an “evolved NodeB” or “eNodeB” and, in the context of a fifth generation (5G) New Radio (NR) system, may also be referred to as a “gNodeB”). In general, the base station 100 is configured to provide wireless service to various items of user equipment (UEs) 104 served by the cell 102. Unless explicitly stated to the contrary, references to Layer 1, Layer 2, Layer 3, and other or equivalent layers (such as the Physical Layer or the Media Access Control (MAC) Layer) refer to the particular wireless interface (for example, 4G LTE or 5G NR) used for wirelessly communicating with UEs 104 served by the cell 102.

In the exemplary embodiment shown in FIG. 1, for each cell 102, the associated base station 100 is partitioned into a set of one baseband unit (BBU) entities 106 that interact with multiple remote units 110 (also referred to here as “radio points” or “RPs”) in order to provide wireless service to various items of the UEs 104. In the exemplary embodiment shown in FIG. 1, the set of one or more BBU entities 106 may comprise a single entity (also referred to here as a “baseband controller” or simply a “baseband band unit” or “BBU”) that performs the Layer-3, Layer-2, and some Layer-1 processing for the cell 102. In other embodiments, the set of one or more BBU entities 106 may comprise multiple entities, for example, one or more central unit (CU) entities that implement the control-plane and user-plane Layer-3 functions for the cell 102, and one or more distributed units (DU) that implement the Layer-2 functions for cell 102 and some of the control-plane and user-plane Layer-1 functions for cell 102. In general, the remote units 110 implement the control-plane and user-plane Layer-1 functions not implemented by the BBU entities as well as the radio frequency (RF) functions and may comprise the corresponding RF hardware (such as amplifiers, filters, signal processing, and so forth) to implement those functions.

Generally, each RU 110 is remotely located from each of the other RUs 110 serving the associated cell 102 as well as from the BBU entity 106 serving it. The RUs 110 are communicatively coupled to the BBU entity 106 serving the cell 102 via a fronthaul network 120 (for example, using a switched Ethernet network and the Internet Protocol (IP)). In some examples, at least some of the RUs 110 are remote antenna units of a distributed antenna system (DAS), which are communicatively coupled to the BBU entity 106 via a master unit of the DAS. In some such examples, the remote antenna units of the DAS are communicatively coupled to the master unit via one or more intermediate nodes between the remote antenna units and the master unit.

The BBU entity 106 is coupled to a core network 124 of the associated wireless network operator over an appropriate backhaul network 126 (such as the Internet). Core network 124 may further include a device management system (DMS) 125 for configuring one or more aspects of the RAN 100. The BBU entity 106 includes suitable network interfaces to couple it to the fronthaul network 120 in order to facilitate communications between the BBU entity 106 and the RUs 110. Likewise, the BBU entity 106 includes suitable network interfaces to couple it to the backhaul network 126 in order to facilitate communications between the BBU entity 106 and the core network 124. The resulting architecture, as further described by this disclosure, provides for a cell 102 that can operate in a unified manner with no borders between radio units and employs joint transmission and reception so that handovers of mobile UE moving between radio coverage areas is avoided.

Each BBU entity 106 and RU 110, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each BBU entity 106 and RU 110 can be implemented as a physical function (PF) (for example, using dedicated physical programmable devices and other circuitry) and/or a virtual function (VF) (for example, using one or more general purpose servers (possibly with hardware acceleration) in a scalable cloud environment) and in different locations within an operator's network (for example, in the operator's “edge cloud” or “central cloud”).

Each BBU entity 106 and RU 110, and any of the specific features described here as being implemented thereby, can be implemented in other ways.

The base station 100 is configured to wirelessly communicate with each UE 104 served by the base station 100 using a respective subset of the RUs 110 serving that cell 102. This respective subset of RUs 110 for each UE 104 is also referred to here as the “signal zone” (SZ) 103 for that UE 104. That is, downlink data is wirelessly transmitted to a given UE 104 by wirelessly transmitting that downlink data from the RUs 110 included in that UE's signal zone 103, and uplink data is wirelessly received from a given UE 104 by combining data received at the RUs 110 included in that UE's signal zone 103. The SZ 103 used for transmitting data to a UE 104 may be different from the SZ 103 used for receiving data from the UE 104. However, in the following description, for ease of explanation, it is assumed that the SZ 103 used for transmitting data to a UE 104 is the same as the SZ 103 used for receiving data from that UE 104.

The signal zone can vary from UE-to-UE and a given UE's signal zone can change as the UE 104 moves throughout the coverage area associated with the cell 102. The “size” of a signal zone 103 refers to the number of remote units 110 that are included in that signal zone. In general, the signal zone for a UE 104 includes those remote units 110 that have the “best” or “strongest” signal reception characteristics for that UE 104, assuming those remote units 110 have sufficient capacity.

The base station 100 is configured to support frequency reuse. “Frequency reuse” refers to situations where separate data (including, user data, control data, reference signals, etc.) intended for different UEs 104 is simultaneously wirelessly transmitted to the UEs 104 using the same physical resource blocks (PRBs) for the same cell 102 but using different sets of one or more RUs 110. Such reuse UEs 104 are also referred to here as being “in reuse” with each other. For those PRBs where frequency reuse is used, each of the multiple reuse UEs 104 is served by a different subset of the RUs 110, where no RU 110 is used to serve more than one UE 104 for those reused PRBs.

FIG. 1A is a block diagram illustrating an implementation where the BBU entity 106 comprises a baseband controller 140. As shown in FIG. 1A, the baseband controller 140 comprises a processor 150 coupled to a memory 152 (a non-transitory storage medium or media) where the processor 150 executes program instructions read from the memory 152 in order to perform one or more functions described here as being implemented by the baseband controller 140. Relevant to the embodiments described herein for a RAN having RUs with different transmit signal powers, the functions of the baseband controller 140 executed by the processor 150 include a RU power assessment function 154 and an information block (IB) dissemination function 162, which utilize RU configuration data 160. Each of these are discussed in greater detail below. FIG. 1B is a block diagram of an alternate implementation where the BBU entity 106 comprises one or more central units (CU) 170 and one or more distributed units (DU) 172 as discussed above. In such an embodiment, each DU 172 may be coupled to one or more of the RUs 110. Here, the processor 150 and memory 152 are comprised within the DU 172, which also includes the RU power assessment function 154, information block (IB) dissemination function 162, and RU configuration data 160.

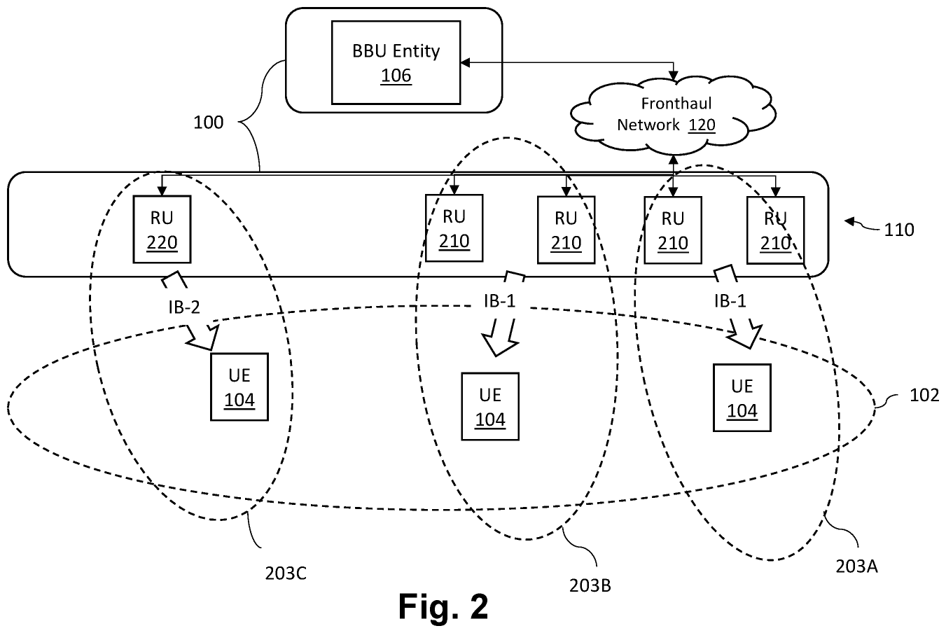

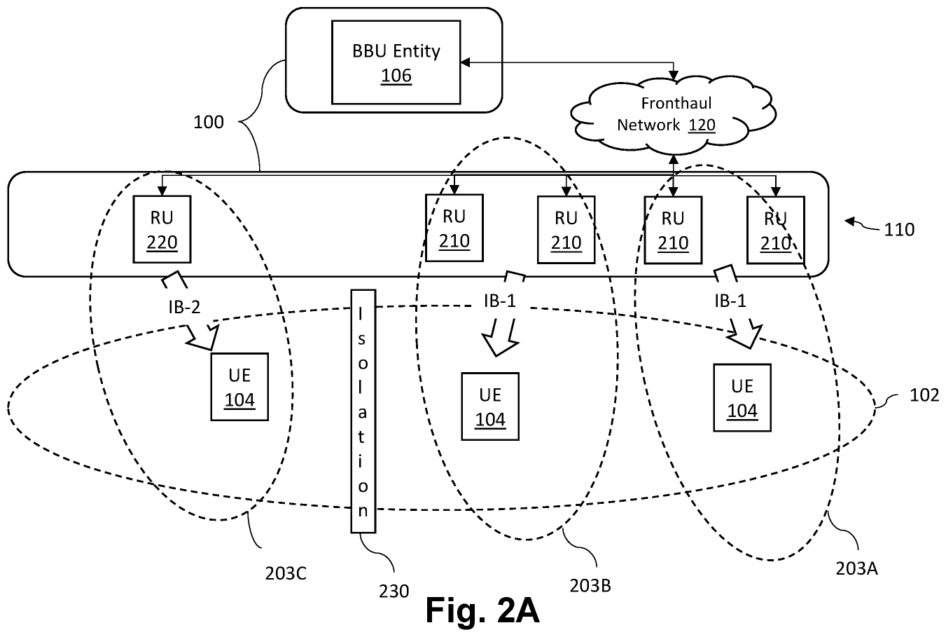

Referring to FIG. 2, the RAN 100 is illustrated in an example implementation where plurality of the RUs 110 (shown as RUs 210) operates at a first transmit signal power, but at least one of the RUs 110 (shown as RU 220) operates at a second transmit signal power that is a higher signal power than that used by the RUs 210. In some embodiments, the RU 220 may comprise an outdoor RU (for example, housed in a weatherproof enclosure) while the RUs 210 are indoor RUs.

In this embodiment, the BBU entity 106 reads from the RU configuration data 160, configuration information for the RUs 110 (RUs 210 and/or RU 220) including the transmit signal power associated with the respective RU 110. In some embodiments, the transmit signal power associated with each RU 110, along with other RU parameters, is configurable from the DMS 125. These parameters are communicated from the DMS 125 to the BBU entity 106 where they are stored as RU configuration data 160. In some embodiments, the desired transmit power allocated to an RU 110 accounts for various gains and losses that contribute to the Effective Isotropic Radiated Power (EIRP) actually radiated into the coverage area 102. For example, the effective power radiated into the coverage area 102 by an RU 110 is a function of both the transmit power of the RU's radio transmitter and the gain of the RU antenna.

With embodiments of the present disclosure, each of the RU 110 receive from the BBU entity 106, a specific SIB information block that includes a transmit signal power indication specific to the transmit signal power they radiate. In the example implementation of FIG. 2, the RUs 210 are provided by the BBU entity 106 a first information block (IB-1) that indicates the signal power of the downlink signal they transmit into the coverage area 102. A UE 104 having a signal zone 103 that includes the RUs 210 (such as shown by CZ 203A and CZ 203B) will receive the first information block (IB-1) from the RUs 210 to which they are connected and from there calculate their path loss and adjust their own uplink transmit signal power accordingly. The RU 220 is instead provided by the BBU entity 106 a second information block (IB-2) that indicates the signal power of the downlink signal that it transmits into the coverage area 102. A UE 104 having a signal zone 103 that includes the RU 220 (such as shown by CZ 203C) will receive the second information block (IB-2) from the RU 220 to which it is connected and from there calculate the path loss and adjust its own uplink transmit signal power accordingly.

In one embodiment, to generate the specific IB(s) that are sent to the RUs 110, the RU Power Assessment function 154 reads from the RU configuration data 160 and determines the transmit signal power radiated by each RU 110. The RU Power Assessment function 154 then generates a specific IB for each set of RUs 110 having the same designated transmit signal power. Accordingly for all RUs 210, which all transmit at the same signal power, the RU Power Assessment function 154 produces the first IB (IB-1) and for the RU 220 (and any other RUs that transmit at the same signal power as RU 220) the RU Power Assessment function 154 produces the second IB (IB-2). The IBs produced by the RU power assessment function 154 are forwarded to their associated RU by the IB dissemination function 162. In some embodiments, each RU 110 is in communication with the BBU entity 106 via the fronthaul network 120 and has its own unique network address to facilitate communication with the BBU entity 106. For example, the IB dissemination function 162 may route to each RU 110 their appropriate IB utilizing their network address.

The RUs 110 each therefore receive from the BBU entity 106 a specific IB appropriate for their specific transmit power level and transmit that IB into the coverage area 102. The UE 104 having a signal zone SZ 203A or 203B will receive first information block (IB-1) from an RU 210 to which it is connected. A UE 104 having a signal zone 203C will receive the second information block (IB-2) from RU 220 to which it is connected.

Because each UE 104 is configured to be able establish connections with any of the RUs 110 reachable within their signal zone 103 (including more than one of the RUs 110 at a given time), it would be theoretically possible (in the absence of isolation) for a UE 104 communicating via an RU 210 to inadvertently acquire an IB-2 from the RU 220, or inversely for a UE 104 communicating via RU 220 to inadvertently acquire an IB-1 from the RU 220. Either scenario would result in the UE 104 erroneously calculating its path loss and incorrectly adjusting its own uplink transmit signal power accordingly. For example, a UE 104 in SZ 203B that receives an errant IB-2 from RU 220 would compute the difference in power between the IB-2 indicated power level and the signal power received from the RU 210 and from that calculate an erroneously high path loss. The UE 104 would necessarily increase it uplink transmit signal power, potentially saturating the receive path of the RU 210 it is connected to, or interfering with the BBU entity's ability to correctly aggregate uplink signals from the various RUs 110 for further uplink transmission to the core network 124.

In order to mitigate against a UE 104 from decoding IBs from two adjacent RU 110 that have different IBs, in some embodiments sufficient isolation is provided (for example, at least isolation of 3 dB) as shown at 230 in FIG. 2A. That is, the isolation 230 ensures that the IB-2 transmitted by RU 220 is seen as sufficiently undesirable for decoding that it will not be utilized by a UE 104 connected to an adjacent RU 210. Instead, the isolation 230 provides that UE 104 would inherently always prefer the IB-1 it receives from its RU 210. In some embodiments, transmit power from one or both RUs can be adjusted (for example, reduced) to obtain the 3 dB isolation. In some embodiments, differential transmit power can be achieved without modification of the information block. For example, when no information block is sent to a UE 104 that includes information about a transmit power change for a specific RU 210, the UE 104 may instead compute the different pathloss. Here, the RAN 100 computes an actual path loss by compensating a delta power that is not advertised to a UE 104 via the information block. Further, the RAN 100 controls the UE 104 uplink power via a power control method to obtain a desired uplink power level. This permits the system to operate without modification of the information block.

In some embodiments, the isolation 230 may be implemented using purely passive isolation. For example, isolation 230 may be implemented during deployment of the RUs 110 by locating the RU 210 and the RU 220 at a sufficient distance from each other, or where there exists architectural structural elements (such as building walls or frameworks), that attenuate signals between the locations, for example, by at least 3 dB. The UE 104 would disregard the more attenuated signal and instead decode the IB from an RU 110 with which it is actively connected. As such, the UE 104 would always decode the appropriate IB, even when the RU 210 and RU 220 are transmitting their different IBs at the same time or in the same downlink signal resource block.

In other embodiments, active isolation 230 may instead (or also) be implemented. Active isolation permits overlap in RF signals, but still provides the isolation to support reuse via protocol level parameters, frequency and/or time domain resource allocation differences, and the like. The active isolation discussed herein may be implemented by an isolation management function 163 executed by the processor 150. In one embodiment, active isolation 230 includes utilization of different downlink signal resource blocks for transmitting different IBs into the coverage area 102. In some examples, a RU 210 would indicate to the UE 104 that it transmits it IB (IB-1) in a first downlink resource block, while the RU 220 would indicate to the UE 104 that it transmits its different IB (IB-2) in a second downlink resource block. In some examples, IB-1 and IB-2 can be transmitted as different SSBs within an SSB burst. Isolation would thus be achieved by utilizing different downlink resource blocks to transmit different IBs. In one embodiment, when a UE 104 connects to a RU 110, it identifies the resource block it should use to acquire the correct IB from that RU 110, and continues to utilize that resource block for as long as that RU 110 remains within its SZ 103.

Other forms of active isolation 230 include what is referred to herein as “protocol implemented isolation.” Protocol implemented isolation comprises any isolation that can be established by adjusting parameters of the wireless protocol. For example, different IBs can be transmitted using different scrambling codes (IDs) and/or Cell IDs. Alternatively, for RUs 110 that implement Multiple-Input, Multiple-Output (MIMO) communications, the antenna port(s) used to transmit the IB can be configured differently for different IBs.

In other embodiments, protocol implemented isolation may include configuring the ratio of pilot carrier versus data carrier power (ρₐ/ρ_{b}) at different points in time to assist UE 104 in decoding the appropriate IB for the RU(s) 110 they are connected to. For example, if RU 220 is adjusted to have a different ρₐ/ρ_{b} by boosting the pilot carrier power compared to the ρₐ/ρ_{b} of a neighboring RU 210, then a UE 104 proximate to the RU 220 will not be able to decode an IB from the RU 210. The UE 104 will select signals from the RU 220 and thus have a natural rejection or isolation with respect to RU 210.

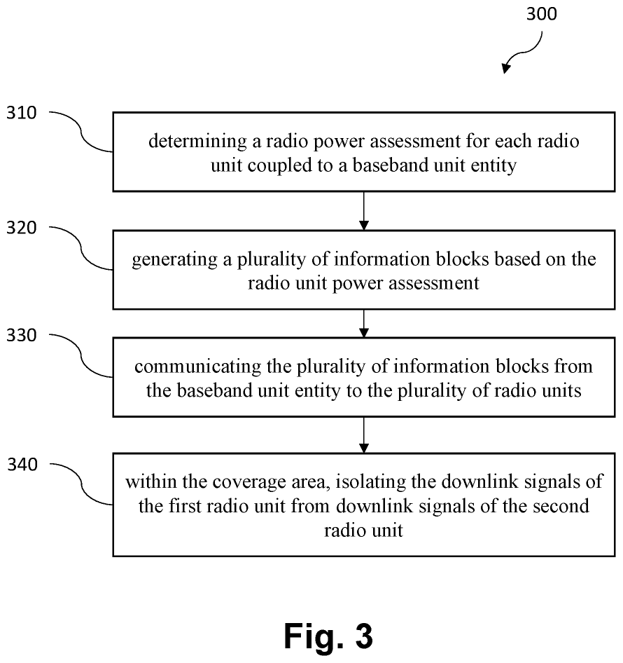

FIG. 3 is a flow chart diagram illustrating a method 300 of one embodiment of the present disclosure for select radio unit transmission power in a radio access network. It should be understood that method 300 may be implemented using any one of the embodiments described above. As such, elements of method 300 may be used in conjunction with, in combination with, or substituted for elements of any of the embodiments described herein. Further, the functions, structures, features, and other description of elements for such embodiments described herein may apply to like named elements of method 300 and vice versa.

The method begins at 310 with determining a radio power assessment for each radio unit coupled to a BBU entity. The radio power assessment is based on radio unit configuration data. In some embodiments, the radio unit configuration data is provided to the BBU entity by a device management system. The method proceeds to 320 with generating a plurality of information blocks based on the radio unit power assessment. In some embodiments, the information blocks may comprise a System Information Block (SIB). The information blocks each comprise a transmit signal power indication used by the radio units to set the signal power of the downlink signal they transmit into the coverage area 102. The method proceeds to 330 with communicating the plurality of information blocks from the BBU entity to the plurality of radio units. A first information block communicated to a first radio unit indicates to transmit downlink signals into the coverage area at a first power level. A second information block communicated to a second radio unit indicates to transmit downlink signals into the coverage area at a second power level either greater or less than the first power level. The method proceeds to 340 with, within the coverage area, isolating the downlink signals of the first radio unit from downlink signals of the second radio unit.

### Example Embodiments

Example 1 includes a controller for a radio access network, wherein the radio access network includes a baseband unit entity coupled to a plurality of radio units providing wireless communications service to user equipment (UE) in a coverage area, the controller comprising: a processor configured to execute: a radio unit power assessment function, wherein the radio unit power assessment function determines a transmit power level for each of the plurality of radio units based on radio unit configuration data; an information block dissemination function configured to communicate an information block to each of the plurality of radio units based on the transmit power level for each of the plurality of radio units determined by the radio unit power assessment function; wherein the information block dissemination function is configured to communicate a first information block to a first radio unit of the plurality of radio units that indicates to transmit downlink signals into a coverage area at a first power level; wherein the information block dissemination function is configured to communicate a second information block to a second radio unit of the plurality of radio units that indicates to transmit downlink signals into the coverage area at a second power level either greater or less than the first power level; and wherein within the coverage area, the downlink signals of the first radio unit are isolated from downlink signals of the second radio unit.

Example 2 includes the controller of Example 1, wherein the downlink signals of the first radio unit are isolated from downlink signal of the second radio unit by passive isolation.

Example 3 includes the controller of Example 2, wherein the information block dissemination function is configured to transmit the first information block to the first radio unit and the second information block to the second radio unit via the same downlink resource block.

Example 4 includes the controller of any of Examples 1-3, wherein the downlink signals of the first radio unit are isolated from downlink signal of the second radio unit by active isolation, wherein the active isolation is controlled by an isolation management function executed by the processor.

Example 5 includes the controller of Example 4, wherein the active isolation comprises transmitting the first information block to the first radio unit via a first downlink resource block and transmitting the second information block to the second radio unit via a second downlink resource block.

Example 6 includes the controller of any of Examples 4-5, wherein the active isolation includes protocol implemented isolation, wherein the isolation management function manages the active isolation by: utilizing different scrambling codes; utilizing different Cell IDs; utilizing different Multiple-Input, Multiple-Output (MIMO) antenna port configurations; and/or controlling a ratio of pilot carrier versus data carrier power used by radio units.

Example 7 includes the controller of any of Examples 1-6, wherein the controller comprises a baseband controller or a baseband unit.

Example 8 includes the controller of any of Examples 1-7, wherein the controller comprises a central unit (CU) and at least one distribution unit (DU), wherein the plurality of radio units is coupled to the controller via the DU.

Example 9 includes the controller of any of Examples 1-8, wherein the controller simultaneously communicates with different UEs using different sets of different radio units.

Example 10 includes a method for select radio unit transmission power in a radio access network that includes a baseband unit entity coupled to a plurality of radio units providing wireless communications service to user equipment (UE) in a coverage area, the method comprising: determining a radio power assessment for each of the plurality of radio units coupled to the baseband unit entity, wherein the radio power assessment is based on radio unit configuration data; generating a plurality of information blocks based on the radio power assessment, communicating the plurality of information blocks from the baseband unit entity to the plurality of radio units, wherein a first information block communicated to a first radio unit indicates to transmit downlink signals into the coverage area at a first power level, wherein a second information block communicated to a second radio unit indicates to transmit downlink signals into the coverage area at a second power level either greater or less than the first power level; and within the coverage area, isolating the downlink signals of the first radio unit from downlink signals of the second radio unit.

Example 11 includes the method of Example 10, wherein the downlink signals of the first radio unit are isolated from downlink signal of the second radio unit by a deployment configuration of the plurality of radio units.

Example 12 includes the method of any of Examples 10-11, wherein isolating the downlink signals comprises isolating the downlink signals of the first radio unit from downlink signal of the second radio unit by passive isolation.

Example 13 includes the method of Example 12, further comprising transmitting the first information block to the first radio unit and the second information block to the second radio unit via the same downlink resource block.

Example 14 includes the method of any of Examples 10-13, wherein isolating the downlink signals of the first radio unit from downlink signal of the second radio unit comprises active isolation, wherein the active isolation is controlled by an isolation management function.

Example 15 includes the method of Example 14, wherein the active isolation comprises transmitting the first information block to the first radio unit via a first downlink resource block and transmitting the second information block to the second radio unit via a second downlink resource block.

Example 16 includes the method of any of Examples 14-15, wherein the active isolation includes protocol implemented isolation, wherein the isolation management function manages the active isolation by: utilizing different scrambling codes; utilizing different Cell IDs; utilizing different Multiple-Input, Multiple-Output (MIMO) antenna port configurations; and/or controlling a ratio of pilot carrier versus data carrier power used by radio units.

Example 17 includes the method of any of Examples 10-16, wherein the radio unit configuration data is obtained from a device management system.

Example 18 includes the method of any of Examples 10-17, wherein the baseband unit entity comprises a central unit (CU) and at least one distribution unit (DU), wherein the plurality of radio units is coupled to the baseband unit entity via the DU.

Example 19 includes the method of any of Examples 10-18, wherein at least one information block of the plurality of information blocks does not indicate a transmit power change for a specific radio unit, the method further comprising: computing, by the baseband unit entity, an actual path loss by compensating a delta power that is not advertised to a UE via the at least one information block of the plurality of information blocks.

Example 20 includes the method of any of Examples 10-19, wherein the plurality of radio units includes a plurality of remote antenna units of a distributed antenna system.

Example 21 includes a radio access network comprising the controller of any of Examples 1-9.

In various alternative embodiments, system and/or device elements, method steps, or example implementations described throughout this disclosure (such as any of the base stations, baseband controller, radio units, core network, device management system, or sub-parts thereof, for example) may be implemented at least in part using one or more computer systems, field programmable gate arrays (FPGAs), or similar devices comprising a processor coupled to a memory and executing code to realize those elements, processes, or examples, said code stored on a non-transient hardware data storage device. Therefore, other embodiments of the present disclosure may include elements comprising program instructions resident on computer readable media which when implemented by such computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

As used herein, cloud-based virtualized wireless base station related terms such as base stations, baseband controller, baseband unit, radio unit, radio point, core network, user equipment, device management system, fronthaul network, backhaul network, or sub-parts thereof, refer to non-generic elements as would recognized and understood by those of skill in the art of telecommunications and networks and are not used herein as nonce words or nonce terms for the purpose of invoking 35 USC 112(f).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. A controller for a radio access network, wherein the radio access network includes a baseband unit entity coupled to a plurality of radio units providing wireless communications service to user equipment (UE) in a coverage area, the controller comprising:
a processor configured to execute:
a radio unit power assessment function, wherein the radio unit power assessment function determines a transmit power level for each of the plurality of radio units based on radio unit configuration data;
an information block dissemination function configured to communicate an information block to each of the plurality of radio units based on the transmit power level for each of the plurality of radio units determined by the radio unit power assessment function;
wherein the information block dissemination function is configured to communicate a first information block to a first radio unit of the plurality of radio units that indicates to transmit downlink signals into a coverage area at a first power level;
wherein the information block dissemination function is configured to communicate a second information block to a second radio unit of the plurality of radio units that indicates to transmit downlink signals into the coverage area at a second power level either greater or less than the first power level; and
wherein within the coverage area, the downlink signals of the first radio unit are isolated from downlink signals of the second radio unit.

2. The controller of claim 1, wherein the downlink signals of the first radio unit are isolated from downlink signal of the second radio unit by passive isolation.

3. The controller of claim 2, wherein the information block dissemination function is configured to transmit the first information block to the first radio unit and the second information block to the second radio unit via the same downlink resource block.

4. The controller of claim 1, wherein the downlink signals of the first radio unit are isolated from downlink signal of the second radio unit by active isolation, wherein the active isolation is controlled by an isolation management function executed by the processor.

5. The controller of claim 4, wherein the active isolation comprises transmitting the first information block to the first radio unit via a first downlink resource block and transmitting the second information block to the second radio unit via a second downlink resource block.

6. The controller of claim 4, wherein the active isolation includes protocol implemented isolation, wherein the isolation management function manages the active isolation by:
utilizing different scrambling codes;
utilizing different Cell IDs;
utilizing different Multiple-Input, Multiple-Output (MIMO) antenna port configurations; and/or
controlling a ratio of pilot carrier versus data carrier power used by radio units.

7. The controller of claim 1, wherein the controller comprises a baseband controller or a baseband unit.

8. The controller of claim 1, wherein the controller comprises a central unit (CU) and at least one distribution unit (DU), wherein the plurality of radio units is coupled to the controller via the DU.

9. The controller of claim 1, wherein the controller simultaneously communicates with different UEs using different sets of different radio units.

10. A method for select radio unit transmission power in a radio access network that includes a baseband unit entity coupled to a plurality of radio units providing wireless communications service to user equipment (UE) in a coverage area, the method comprising:
determining a radio power assessment for each of the plurality of radio units coupled to the baseband unit entity, wherein the radio power assessment is based on radio unit configuration data;
generating a plurality of information blocks based on the radio power assessment,
communicating the plurality of information blocks from the baseband unit entity to the plurality of radio units, wherein a first information block communicated to a first radio unit indicates to transmit downlink signals into the coverage area at a first power level, wherein a second information block communicated to a second radio unit indicates to transmit downlink signals into the coverage area at a second power level either greater or less than the first power level; and
within the coverage area, isolating the downlink signals of the first radio unit from downlink signals of the second radio unit.

11. The method of claim 10, wherein the downlink signals of the first radio unit are isolated from downlink signal of the second radio unit by a deployment configuration of the plurality of radio units.

12. The method of claim 10, wherein isolating the downlink signals comprises isolating the downlink signals of the first radio unit from downlink signal of the second radio unit by passive isolation.

13. The method of claim 12, further comprising transmitting the first information block to the first radio unit and the second information block to the second radio unit via the same downlink resource block.

14. The method of claim 10, wherein isolating the downlink signals of the first radio unit from downlink signal of the second radio unit comprises active isolation, wherein the active isolation is controlled by an isolation management function.

15. The method of claim 14, wherein the active isolation comprises transmitting the first information block to the first radio unit via a first downlink resource block and transmitting the second information block to the second radio unit via a second downlink resource block.

16. The method of claim 14, wherein the active isolation includes protocol implemented isolation, wherein the isolation management function manages the active isolation by:
utilizing different scrambling codes;
utilizing different Cell IDs;
utilizing different Multiple-Input, Multiple-Output (MIMO) antenna port configurations; and/or
controlling a ratio of pilot carrier versus data carrier power used by radio units.

17. The method of claim 10, wherein the radio unit configuration data is obtained from a device management system.

18. The method of claim 10, wherein the baseband unit entity comprises a central unit (CU) and at least one distribution unit (DU), wherein the plurality of radio units is coupled to the baseband unit entity via the DU.

19. The method of claim 10, wherein at least one information block of the plurality of information blocks does not indicate a transmit power change for a specific radio unit, the method further comprising: computing, by the baseband unit entity, an actual path loss by compensating a delta power that is not advertised to a UE via the at least one information block of the plurality of information blocks.

20. The method of claim 10, wherein the plurality of radio units includes a plurality of remote antenna units of a distributed antenna system.
